(19) United States
(12) Patent Application Publication
(10) Pub. No.: US 2003/0068482 A1
(43) Pub. Date: Apr. 10, 2003

(54) Webs containing microcapsules

(76) Inventors: Friedrich Koch, Koln (DE); Ciro Piermatteo, Leverkusen (DE)

Correspondence Address: BAYER CORPORATION, PATENT DEPARTMENT, 100 BAYER ROAD, PITTSBURGH, PA, 15205, US

(21) Appl. No.: 10/236,760

(22) Filed: Sep. 6, 2002

(30) Foreign Application Priority Data
Sep. 10, 2001 (DE) 10144306.4

(51) Int. Cl. B32B 3/00; C09J 1/00; B32B 31/00

(52) U.S. Cl. 428/313.3; 428/313.5; 428/313.7; 442/417; 156/276

(57) ABSTRACT

The invention relates to webs finished to contain impregnated microcapsules, to a process for producing them and to their use.

### BACKGROUND OF THE INVENTION

1. Field of the Invention

The invention relates to webs finished to contain microcapsules, to a process for producing them and to their use.

Brief Description of Prior Art: WO-A-91/10 375 discloses applying gelatin microcapsules which contain active medical components to the surface of webs by means of a roller. In DE-A-3545 926, scent-containing microcapsules are applied to the surface of webs by spraying.

One disadvantage of the thus finished webs of the prior art is their poor handle. In addition, the subsequent application of a finish always means an additional operation which costs time and money.

It is an object of the present invention to ameliorate the disadvantages of the prior art. This object is achieved by webs finished to contain microcapsules, that are characterized in that they have been impregnated with microcapsules.

### SUMMARY OF THE INVENTION

In accordance with the foregoing, the present invention encompasses webs finished to contain microcapsules, characterized in that they have been impregnated with microcapsules. Also encompassed by the invention is a process for producing webs comprising binder-bonding of unbound web as produced by webbing in the presence of microcapsules, and articles of matter incorporating the webs.

“Impregnated” for the purposes of the invention shall mean that the web has been finished with microcapsules not only on the surface but also in its interior.

### DETAILED DESCRIPTION OF THE INVENTION

In accordance with the invention, web materials include, for example, fibres and fibre blends composed of polyamide, polyester, polyacrylate, cellulose, viscose, rayon, polypropylene or carbon.

The average particle size of the microcapsules is preferably 0.1-100 μm, more preferably 1-30 μm and most preferably 2-20 μm.

Examples of preferred capsule materials are polyureas formed from polyisocyanates and polyamines, polyamides formed from polymeric acyl chlorides and polyamines, polyurethanes formed from polyisocyanate and polyalcohols, polyesters formed from polyisocyanates and polyamines, polyamides formed from polyisocyanates and polyamines, polyesters formed from polymeric acyl chlorides and polyalcohols, epoxy resins formed from epoxy compounds and polyamines, melamine-formaldehyde compounds formed from melamine-formaldehyde prepolymers, urea resins formed from urea-formaldehyde prepolymers, ethylcellulose, polystyrene, polyvinyl acetate, gelatin and also optionally modified starch.

The level of microcapsules in the web is preferably 0.1-100% by weight and especially 0.5-3% by weight, based on the weight of the finished web.

Varying wall thickness is the simplest way of influencing the retention properties of the capsules. This can be used to create “slow release” capsules which, applied to the web, will give off the core material continuously over a long period, preferably longer than 6 months, but also on-demand capsules for webs where the core material is to be released on application of mechanical pressure only.

Preferred wall thicknesses for the microcapsules are in the range of 2-25%, preferably 3-15% and especially 4-10% wall fraction, each percentage being based on the sum total of the capsule core materials including wall or wall-former.

Preference is given to microcapsules whose walls comprise reaction products of guanidine compounds and polyisocyanates.

The wall fraction of the microcapsules is directly proportional to the fraction of the primary wall-former, such as the polyisocyanate.

Useful guanidine compounds for forming the microcapsules include for example those of the formula (I)

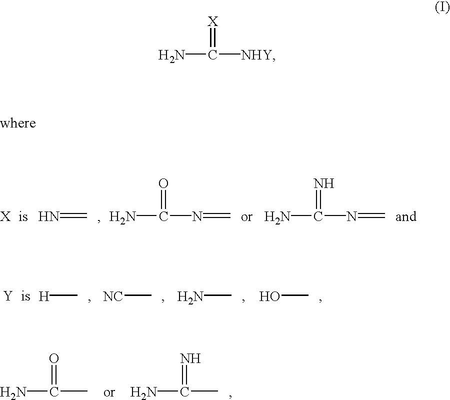

or their salts with acids.

The salts can be, for example, the salts of carbonic acid, nitric acid, sulphuric acid, hydrochloric acid, silicic acid, phosphoric acid, formic acid and/or acetic acid. The use of salts of guanidine compounds of the formula (I) can take place in combination with inorganic bases in order that the salts may be converted in situ into the free guanidine compounds of the formula (I). Useful inorganic bases for this purpose include, for example, alkali and/or alkaline earth metal hydroxides and/or alkaline earth metal oxides. Preference is given to aqueous solutions or slurries of these bases, especially aqueous sodium hydroxide solution, aqueous potassium hydroxide solution or aqueous solutions or slurries of calcium hydroxide. It is also possible to use combinations of a plurality of bases.

It is frequently advantageous to use the guanidine compounds of the formula (I) as salts since they are commercially available in this form and free guanidine compounds are in some instances substantially insoluble in water or not stable in storage. When inorganic bases are used, they may be used in stoichiometric, substoichiometric or superstoichiometric amounts, based on salts of guanidine compounds. Preference is given to using 10 to 100 equivalent % of inorganic base (based on salts of the guanidine compounds). The addition of inorganic bases has the consequence that, for microencapsulation, guanidine compounds having free NH₂ groups are available in the aqueous phase for reaction with the polyisocyanates in the oil phase. For microencapsulation, salts of guanidine compounds and bases are advantageously added separately to the aqueous phase.

Preference is given to using guanidine or salts of guanidine with -carbonic acid, nitric acid, sulphuric acid, hydrochloric acid, silicic acid, phosphoric acid, formic acid and/or acetic acid.

It is particularly advantageous to use salts of guanidine compounds with weak acids. These are in equilibrium with the corresponding free guanidine compound in aqueous solution as a consequence of hydrolysis. The free guanidine compound is consumed during the encapsulation process and is constantly regenerated according to the law of mass action. Guanidine carbonate exhibits this advantage to a particular degree. When salts of guanidine compounds with weak acids are used, there is no need to add inorganic bases to release the free guanidine compounds.

Useful guanidine compounds of the formula (I) for the present invention may also be prepared by ion exchange from their water-soluble salts according to the prior art using commercially available basic ion exchangers. The eluate from the ion exchanger can be utilized directly for capsule wall formation by mixing it with the oil-in-water emulsion.

For example, sufficient guanidine compounds can be used so that 0.2 to 4.0 mol of free NH₂ groups are introduced into or released in the water phase in the form of guanidine compounds per mole of NCO groups present as polyisocyanate in the oil phase. This amount is preferably 0.5 to 1.5 mol. When guanidine compounds are used in a substoichiometric amount, free NCO groups remain after the reaction with the polyisocyanate. These then generally react with water, which is usually not critical since this reaction gives rise to new, free amino groups capable of crosslinking.

The guanidine compounds are preferably used in the form of aqueous solutions. The concentration of such solutions is not critical and is generally limited only by the solubility of the guanidine compounds in water. Useful aqueous solutions of guanidine compounds are 1 to 20% by weight in strength for example.

Useful polyisocyanates for producing microcapsules include a very wide range of aliphatic, aromatic and aromatic-aliphatic difunctional and higher isocyanates, especially those known for producing microcapsules. Preference is given to using aliphatic polyisocyanates. Particular preference is given to using hexamethylene diisocyanate, isophorone-diisocyanate and/or derivatives of hexamethylene diisocyanate and of isophorone diisocyanate that have free isocyanate groups and contain biuret, isocyanurate, uretidione and/or oxadiazinetrione groups. Mixtures of various polyisocyanates can also be used. Some useful polyisocyanates are described for example in EP-A 227 562, EP-A 164 666 and EP-A 16 378.

A preferred embodiment of the webs according to the invention utilizes microcapsules whose walls comprise reaction products of guanidine compounds, polyamines and polyisocyanates.

Preferably, the guanidine compound is used in an amount of 0.5-0.99 and preferably 0.51 to 0.75 mol equivalents, based on polyisocyanate, and the polyamine compound in an amount of 0.1-1 and preferably 0.5 to 0.75 mol equivalents, based on polyisocyanate, the total amount of guanidine compound and polyamine being greater than 1.1 mol equivalents, based on polyisocyanate.

Possible ingredient materials for the microcapsules include various compounds, for example, dye precursors, adhesives, pharmaceuticals, insecticides, fungicides, herbicides, repellants, flame retardants and also scents. Scents are particularly preferred.

Useful scents include all commercially available hydrophobic and hence water-insoluble scents as described, for example, by P. Frakft et al. in Angew. Chem., 2000, 112, 3106-3138. In the case of substances which are soluble in water as well as oils, the addition of odour-neutral, sparingly volatile oils such as paraffins, alkylaromatics or esters can make their use possible.

Advantages of the webs finished according to the invention are their handle and the fact that neither colour nor lustre are altered by an additional after-treatment step.

The invention further provides a process for preparing the webs according to the invention, which have been finished to contain microcapsules, the process being characterized in that unbound web as produced by webbing is subjected to binder bonding in the presence of microcapsules.

Generally, webbing refers to the sheetlike or voluminous disposition of fibres. These fibres can consist, for example, of staple fibres, which are packed in bales or bags, or of filaments which are spun from molten polymer chips.

There are various webbing processes, including dry-laid processes, spinbonding processes, wet-laid processes and others.

There are two kinds of dry-laid processes: carding and air-laid processes. Carding is a mechanical process in which the first step is to open and blend the fibre bales. The fibre is transported to the next processing station by air. The fibre is then combed by a roller card or by a flat card into a web. Cards usually consist of one or more rotating drums equipped with fine wires or teeth. The exact configuration of the roller card depends on the fibre used, the fibre length and the desired weight of web. The web can be oriented in the machine direction or in the cross direction or be oriented as a random layer.

In the air-laid process, the fibres, which are often very short, are introduced into an air stream and carried by the air stream to a conveyor belt or a foraminous drum, where they form a random web.

In the spinbonding process, a polymeric chip is melted and extruded through spinnerets. These continuous filament fibres are cooled and laid down on a support to form a uniform web.

In the wet-laid process, generally a very dilute suspension of water and fibre is preferably fed onto an endless foraminous belt. The water is aspirated away to leave the fibrous web. The wet-laid process is preferred.

Binder bonding can be effected in various ways. Preferably, the unbound web is passed through an aqueous binder liquor.

Useful binders include acrylic polymers and copolymers, styrene-butadiene copolymers or vinyl acetate-ethylene copolymers.

The microcapsules used are preferably in the form of an aqueous dispersion containing 5-60% and especially 25-52% by volume of microcapsules, based on the aqueous dispersion, when they are introduced into the binder liquor.

The binder bonding of the webs in the presence of microcapsules is preferably carried out at a temperature of 50 to 200° C.

The aqueous liquor may further include additives such as plasticizers, fillers, colorants and preservatives.

Such an aqueous liquor for the process according to the invention preferably contains:

20-500 g/l of binder

1-100 g/l of plasticizer

1-100 g/l of fillers

0.1-100 g/l of colorants and

0.5-100 g/l of microcapsules.

After binder bonding, the still wet web is generally squeezed off and dried at a temperature of preferably 80 to 140° C.

Other chemical and/or physical aftertreatment steps can follow.

The webs finished according to the invention are useful, for example, as cleaning cloths, head rest web, lining material, shoe parts, automotive parts, etc., according to the microcapsule core material.

The invention is further illustrated but is not intended to be limited by the following examples in which all parts and percentages are by weight unless otherwise specified.

### EXAMPLES

1. Capsules Filled with Scent

While cooling, 0.7 l of a 0.8% solution of polyvinyl alcohol 26/88 -(Airvol® 523, Air Products, having a viscosity of 26 mPas and a degree of deacetylation of 88) in water is initially charged and 0.3 l of a solution of 21 g of polyisocyanate (HDl biuret, NCO content about 22%), in 300 ml of scent is added in the course of 40 s with stirring. This is followed by a further 4 min of emulsification using a high speed rotor-stator mixer (temperature: 20-25° C.) to obtain the desired average particle size. 53 g of 10% guanidine carbonate solution are then added and the dispersion is gradually heated to 70° C. (2 h) with stirring. After a further 2 h at 70° C, the dispersion is cooled to RT and stabilized by addition of 40 ml of thickener (modified starch).

2. Capsules Filled with Scent and Neutral Oil

While cooling, 0.7 l of a 0.8% solution of polyvinyl alcohol 26/88 (Airvol® 523, Air Products) in water is initially charged and 0.3 l of a solution of 21 g of polyisocyanate (HDl biuret, NCO content about 22%), in 50 ml of scent and 450 ml of diisopropylnaphthalene is added in the course of 40 s with stirring. This is followed by a further 4 min of emulsification using a high speed rotor-stator mixer (temperature: 20-25° C.) to obtain the desired average particle size. 53 g of 10% guanidine carbonate solution are then added and the dispersion is gradually heated to 70° C. (2 h) with stirring. After a further 2 h at 70° C., the dispersion is cooled to RT and stabilized by addition of 40 ml of thickener (modified starch).

Appearance and storage stability of capsule dispersions of Examples 1 and 2:

| Example | Scent | Isocyanate |
|---|---|---|
| 1a | Blue Line | HDI biuret |
| 1b | Lennox | HDI biuret |
| 1c | Cuir Naturell | HDI biuret |
| 1d | Blue Line | HDI trimer |
| 1e | Blue Line | HDI biuret + PMDI 1:1 |
| 2a | Blue Line | HDI biuret |
| 2b | Lennox | HDI biuret |
| 2c | Cuir Naturell | HDI biuret |
| 2d | Frutti di Bosco | HDI biuret |
| 2e | Ozonodor | HDI biuret |

PMDI denotes phenylenemethylene diisocyanate.
Scents: Products from Haarmann & Reimer, Holzminden:
Blue Line: mixture of methylisopropylcyclohexene, (diisopropylphenyl)-methylpropanal, lemon oil and dimethyloctadienol in diethyl benzenedicarboxylate;
Cuir Naturell: mixture of dimethylphenol, benzyl alcohol, phenylethyl alcohol, cresol, benzyl benzoate and terpineol in diethyl benzenedicarboxylate;
Frutti di Bosco: mixture of benzyl benzoate, benzyl alcohol, benzaldehyde, allyl caproate, methyl salicylate, orange oil, clove flower oil;
Ozonodor: mixture of turpentine oil, pine needle oil and eucalyptus oil in trimethylbicycloheptanyl acetate;
HDI biuret: NCO content about 23%, viscosity about 2 500 mPas
HDI trimer: NCO content about 22%; viscosity about 3 500 mPas
PMDI: NCO content about 32%, viscosity about 3 000 mPas

The average particle size of the microcapsules described above is 6 μm, determined using a Coulter LS particle size analyzer (evaluation by volume).

3. Microencapsulated Scents in Nonwoven (Cleaning Cloth)

The nonwoven material is produced by mixing the fibres together with the binder and also with other additives such as colorant or fillers. 40 g/l of 50% microcapsulate scent dispersion are added to the mixture.

A polyester-viscose blend web having a waddinglike texture is impregnated with an acrylate binder (Acramin® BA; 40% aqueous dispersion of an acrylonitrile-methacrylic acid-butadiene copolymer from Bayer AG), a colour paste (Levanyl®; pigment paste containing 50% of colouring component from Bayer AG) and microencapsulated (as per Example 1 a, 1 b or 2a) scents on an impregnating range. The material is subsequently dried at 100° C. and thereafter cured at 140° C. for 1 min.

The blend web can be used as a cleaning cloth and for other applications.

| Batch | | 1 |
|---|---|---|
| Binder | g/l | 400 |
| Levanyl | g/l | 5 |
| Scent-containing | g/l | 40 |
| microcapsules | | |

Drying at 100° C. for 1 min

Evaluation of odour after cleaning

| | |
|---|---|
| After web production | ++ |
| After cleaning cloth production | ++ |
| After 10 manual washes at | ++ |
| 40° C. without detergent to DIN | |
| EN 26 330 | |

− no smell of scent
+ very little smell of scent
+ little smell of scent
++ some smell of scent
+++ strong smell of scent

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Webs finished to contain microcapsules, comprising impregnated microcapsules.

2. Webs according to claim 1, wherein the microcapsules contain scents.

3. Process for producing webs according to claim 1, comprising binder bonding of unbound web as produced by webbing in the presence of microcapsules.

4. A process for preparing an article of matter comprising incorporating the webs according to claim 1 as cleaning cloths, head rest webs, lining materials, shoe parts or automotive parts.
